(19) United States
(12) Patent Application Publication
(10) Pub. No.: US 2024/0331994 A1
(43) Pub. Date: Oct. 3, 2024

(54) TIME OF FLIGHT MASS ANALYSIS SYSTEM

(71) Applicant: Thermo Fisher Scientific (Bremen) GmbH, Bremen (DE)

(72) Inventors: Hamish STEWART, Bremen (DE); Bernd HAGEDORN, Bremen (DE); Christian HOCK, Bremen (DE)

(73) Assignee: Thermo Fisher Scientific (Bremen) GmbH, Bremen (DE)

(21) Appl. No.: 18/617,482

(22) Filed: Mar. 26, 2024

(30) Foreign Application Priority Data
Mar. 28, 2023 (GB) 2304506.5

(51) Int. Cl. H01J 49/40; H01J 49/00; H01J 49/42

(52) U.S. Cl. CPC H01J 49/406; H01J 49/0009; H01J 49/0036; H01J 49/422

(57) ABSTRACT

Methods of calibrating a Time of Flight (TOF) mass analyser comprise performing a plurality of calibration analyses of calibrant ions using the TOF mass analyser, each calibration analysis measuring flight times of the calibrant ions. The TOF mass analyser has an associated instrument parameter which effects the flight times of the calibrant ions. Each calibration analysis also comprises determining a reference calibration curve based on known mass to charge ratios of the calibrant ions and the respective flight times, wherein the reference calibration curve is associated with the instrument parameter for the respective calibration analysis. For each calibration analysis, a value of the instrument parameter of the TOF mass analyser is different. A calibration curve for use in a TOF mass analysis performed by the TOF mass analyser can be determined based on the plurality of reference calibration curves and the instrument parameter.

### FIELD OF THE DISCLOSURE

This disclosure relates to Time of Flight (TOF) mass spectrometry and a TOF mass analyser.

### BACKGROUND

In general, a TOF mass analyser determines the mass to charge ratio of an ion by measuring the flight time of the ion between two points. In order to improve the accuracy of the mass to charge ratio determination, the TOF mass analyser may be calibrated by measuring the flight time of ions of a known mass to charge ratio. Such ions may generally be referred to as calibrant ions.

One method for calibrating a TOF mass analyser involves measuring the flight time of calibrant ions (e.g. from a calibration mixture) and fitting the measured times to a polynomial. Typically, a second order polynomial function of the form:

$$m / z = {At}^{2} + Bt + C$$

may be used.

While such an approach can achieve acceptable levels of accuracy, there are various processes occurring within a TOF mass analyser which may cause the time of flight of ions to diverge from a calibration curve. Some divergences are m/z dependent and/or highly non-linear, which may be particularly difficult to capture with a calibration curve.

One known approach is to use a higher order polynomial to fit to the calibration curve. However, such an approach has little relation to the underlying physics of the Time of Flight mass analyser.

GB-A-2426121 discloses a method of interpolating between measured calibration points which requires a wide m/z range of calibrant points to be available.

Calibration functions with parameters informed by simulation or measurement are also known, for example, U.S. Pat. No. 6,437,325B1, and Christian, N. P., Arnold, R. J., & Reilly, J. P. (2000), “Improved calibration of time-of-flight mass spectra by simplex optimization of electrostatic ion calculations”. Such methods do not account for complex m/z dependent behaviours resulting from electronics or deviations between different models.

Against this background, the present disclosure seeks to provide an improved, or at least a commercially relevant alternative, method of calibrating a Time of Flight mass analyser.

### SUMMARY

According to a first aspect, a method of calibrating a Time of Flight (TOF) mass analyser is provided. The method comprises performing a plurality of calibration analyses of calibrant ions using the TOF mass analyser. Each calibration analysis comprises measuring the flight times of the calibrant ions using the TOF mass analyser, wherein the TOF mass analyser has an associated instrument parameter which has an effect on the flight times of the calibrant ions. Each calibration analysis also comprises determining a reference calibration curve for the TOF mass analyser based on the known mass to charge ratios of the calibrant ions and the respective flight times, wherein the reference calibration curve is associated with the instrument parameter of the TOF mass analyser for the respective calibration analysis. For each of the plurality of calibration analyses, a value of the instrument parameter of the TOF mass analyser is different. The method also comprises determining a calibration curve for use in a TOF mass analysis performed by the TOF mass analyser, wherein the calibration curve is determined based on the plurality of reference calibration curves and the instrument parameter of the TOF mass analyser to be used in the TOF mass analysis.

By determining a plurality of reference calibration curves for different values of the instrument parameter, the relationship between the instrument parameter and the measured flight times may be accounted for. In particular, the plurality of reference calibration curves may more accurately account for any non-linear behaviour of the TOF mass analyser, which is challenging to account for using a single calibration measurement.

By determining a calibration curve for a TOF mass analyser based on the plurality of reference calibration curves and the instrument parameter to be used in a subsequent analysis, the method of the first aspect may provide a calibration for a TOF mass analyser with improved accuracy.

In some embodiments, the calibrant ions are initially stored in an ion preparation device, preferably an ion trap, connected to the TOF mass analyser, wherein measuring the flight times of the calibrant ions comprises injecting the calibrant ions from the ion trap into the TOF mass analyser. In some embodiments, the calibrant ions are initially stored in the ion trap by applying an RF trapping voltage. In some embodiments, the instrument parameter associated with each reference calibration curve may be an amplitude or frequency of the RF trapping voltage. As such, in some embodiments, the amplitude and/or frequency of the RF trapping voltage may impact the measured flight times of ions. Accordingly, calibrating the TOF mass analyser to account for the RF trapping voltage setting used with each TOF mass analysis may improve the accuracy of the analysis.

In some embodiments, a time of flight shift model may be determined based on the measured flight times of each of the plurality of calibration analyses, the known m/z of the calibrant ions for each of the plurality analyses, and an amplitude of the RF trapping voltage for each the plurality of calibration analyses. As such, the amplitude of the RF trapping voltage may cause a shift in the observed flight time for a calibrant ion of known m/z. That is to say, the observed flight time may be shifted (i.e. different to) an expected flight time for the calibrant ion based on its known m/z. This shift in time of flight may be characterised by a model (e.g. a polynomial) fitted to the observed time of flight shifts from the calibration analyses. In some embodiments, each reference calibration curve may be determined based on the known mass to charge ratios of the calibrant ions, the time of flight shift model, and the respective flight times. As such, the time of flight shift model may be utilised to improve the accuracy of the reference calibration curves determined under different RF voltage amplitudes.

In some embodiments, the flight times used to determine each reference calibration curve are based on the time of flight shift model and the measured flight time. As such, in some embodiments, where the instrument parameter is different to the amplitude of the RF trapping voltage, the effect of the amplitude of the RF trapping voltage may be accounted for by correcting the flight times used to determine each reference calibration curve.

In some embodiments, the plurality of calibration analyses comprise: a first calibration analysis where the calibrant ions are first calibrant ions having a first set of mass to charge ratios; and a second calibration analysis where the calibrant ions are second calibrant ions having a second set of mass to charge ratios different to the first set of mass to charge ratios of the first calibrant ions. As such, each of the first and second calibration analyses may cover a different mass to charge range of interest, wherein each of the first and second calibration analyses is performed with a different instrument parameter.

In some embodiments, the plurality of calibration analyses comprise: a first calibration analysis from which a first reference calibration curve is determined, the first reference calibration curve defined between a first mass to charge value and a second mass to charge value. The plurality of calibration analyses may also comprise a second calibration analysis from which a second reference calibration curve is determined, the second reference calibration curve defined between a third mass to charge value and a fourth mass to charge value, wherein the fourth mass to charge value is outside the range defined by the first and second mass to charge values. As such, in some embodiments the mass to charge range defined by the third and fourth mass to charge values may partially overlap with the mass to charge range defined by the first and second mass to charge values. In some embodiments, the mass to charge range defined by the third and fourth mass to charge values may not overlap with the mass to charge range defined by the first and second mass to charge values. It will be appreciated that where a plurality of calibration analyses are provided, the mass to charge range of one or more of the calibration analyses may overlap with one or more of the other calibration analyses. Each of the calibration analyses may have a different instrument parameter setting. Accordingly, the plurality of reference calibration curves determined may provide information on the non-linearities associated with the instrument parameter for a range of different instrument parameter settings and for different mass to charge ranges.

In some embodiments, a calibration curve is determined based on the reference calibration curve of the plurality of reference calibration curves having an associated instrument parameter which is closest to the instrument parameter of the TOF mass analyser to be used in the TOF mass analysis. As such, in some embodiments, an instrument parameter to be used in a TOF mass analysis may not correspond to an instrument parameter for which there is a reference calibration curve. In such cases, the TOF mass analyser may determine the calibration curve based on a reference calibration curve having an associated instrument parameter which is closest to the instrument parameter of interest. Thus, the calibration of the TOF mass analyser may take into account the effect of the instrument parameter on the measured flight time, thereby improving the accuracy of the calibration of the TOF mass analyser.

In some embodiments, a calibration curve is determined by interpolating between two of the reference calibration curves having associated instrument parameters which bound the instrument parameter to be used in the TOF mass analysis. By using interpolation to determine a calibration curve, the method may take into account a plurality of reference calibration curves, which may improve the accuracy of the calibration of the TOF mass analyser.

It will be appreciated that the method of the first aspect relates to the determination of a plurality of reference calibration curves and the determination of a calibration curve for a given instrument parameter setting. Such a method may be performed upon set-up of a TOF mass analyser such that the determined calibration curve is available for use by a user of the TOF mass analyser. As such, the method of the first aspect relates to calibration of the TOF mass analyser, including performing a plurality of calibration analyses using calibrant ions. Once the reference calibration curves are determined using the calibrant ions, a calibration curve may be determined for ions of a sample to be analysed.

Thus, according to a second aspect of the disclosure, a method of Time of Flight mass spectrometry for a mass to charge ratio range of interest using a TOF mass analyser is provided. The method of the second aspect comprises:
providing a plurality of ions having mass to charge ratios within the mass to charge ratio range of interest,
measuring the flight times of the ions using the TOF mass analyser, wherein the TOF mass analyser has an associated instrument parameter used to measure the flight times;
obtaining a calibration curve for the TOF mass analyser wherein, the calibration curve is obtained based on:
   a plurality of reference calibration curves, each reference calibration curve associated with a different value for the instrument parameter of the TOF mass analyser; and
   the instrument parameter of the TOF mass analyser used to measure the flight times of the ions; and
applying the calibration curve to the measured flight times of the ions in order to determine mass to charge ratios for the ions.

As such, the method of the second aspect relates to performing a method of TOF mass spectrometry which makes use of the reference calibration curves determined according to the first aspect. It will be appreciated that it is not required to obtain the reference calibration curves each time a TOF mass analysis is performed. However, in some embodiments, the calibration curve to be applied may be determined from the reference calibration curves each time a TOF mass analysis is performed based on the instrument parameter.

In some embodiments, the ions are initially stored in an ion preparation device, preferably an ion trap, connected to the TOF mass analyser, wherein measuring the flight times of the ions comprises injecting the ions from the ion trap into the TOF mass analyser. In some embodiments, the ions are initially stored in the ion trap by applying an RF trapping voltage, wherein the instrument parameter associated with each reference calibration curve is an amplitude or frequency of the RF trapping voltage. As such, in some embodiments, the amplitude and/or frequency of the RF trapping voltage may impact the measured flight times of ions. Accordingly, calibrating the TOF mass analyser to account for the RF trapping voltage setting used with each TOF mass analysis may improve the accuracy of the analysis.

In some embodiments, the mass to charge range of interest and the associated instrument parameter are specified by a user. As such, in some embodiments, the instrument parameter may be selected based on the mass to charge range of interest specified by the user. For example, for the injection of ions into the TOF mass analyser, one or more instrument parameters associated with the injection of ions may be specified based on the mass to charge ratio of the ions to be analysed, for example to improve the injection efficiency of ions into the TOF mass analyser. However, such an instrument parameter may also affect the calibration of the TOF mass analyser. The method according to the second aspect provides a method of determining a calibration curve which accounts for the instrument parameter selected in order to improve the accuracy of the analysis.

In some embodiments, the mass to charge range of interest comprises a first subrange having an associated first instrument parameter and a second subrange having an associated second instrument parameter, the first and second instrument parameters being different. In some embodiments, the method of TOF mass spectrometry comprises: measuring the flight times of the ions having a mass to charge ratio within the first subrange using the first instrument parameter, and measuring the flight times of the ions having a mass to charge ratio within the second subrange using the second instrument parameter. In some embodiments, a first calibration curve is determined for the first subrange, and a second calibration curve is determined for the second subrange. As such the method of mass spectrometry may vary the instrument parameter over a mass to charge range of interest, wherein the calibration curve used is also updated in accordance with the variation in the instrument parameter.

According to a third aspect of the disclosure, a Time of Flight (TOF) mass analysis system is provided. The TOF mass analysis system comprises: a Time of Flight (TOF) mass analyser; and a controller. The TOF mass analysis system has an instrument parameter which is controlled by the controller, wherein the instrument parameter has an effect on the flight time of a calibrant ion. The controller is configured to cause the TOF mass analyser to perform a plurality of calibration analyses of calibrant ions. Each calibration analysis comprises measuring the flight times of the calibrant ions using the TOF mass analyser; and determining a reference calibration curve for the TOF mass analyser based on known mass to charge ratios of the calibrant ions and the respective flight times, wherein the reference calibration curve is associated with the instrument parameter of the TOF mass analyser for the respective calibration analysis. For each of the plurality of calibration analyses, a value of the instrument parameter of the TOF mass analyser is different. The controller is also configured to determine a calibration curve for use in a TOF mass analysis performed by the TOF mass analyser, wherein the calibration curve is determined based on the plurality of reference calibration curves and the instrument parameter of the TOF mass analyser to be used in the TOF mass analysis.

As such, a TOF mass analysis system, for example a TOF mass spectrometer, may be provided which is configured to perform the method of the first aspect. It will be appreciated that the TOF mass analysis system of the third aspect may be configured to perform any of the optional features discussed above in relation to the first aspect (and also the second aspect).

In some embodiments, the TOF mass analysis system may comprise an ion preparation device, preferably an ion trap, which is configured to store calibrant ions and to inject calibrant ions into the TOF mass analyser. For each calibration analysis, the controller may be configured to cause the ion preparation device to inject the calibrant ions from the ion trap into the TOF mass analyser. In some embodiments, the ion trap is configured to apply an RF trapping voltage to store the calibrant ions in the ion trap. In some embodiments, the instrument parameter associated with each reference calibration curve is an amplitude or frequency of the RF trapping voltage. As such, in some embodiments, the amplitude and/or frequency of the RF trapping voltage may impact the measured flight times of ions. Accordingly, calibrating the TOF mass analyser to account for the RF trapping voltage setting used with each TOF mass analysis may improve the accuracy of the analysis.

In some embodiments, the controller is configured to cause the TOF mass analyser to perform plurality of calibration analyses comprising causing the TOF mass analyser to perform a first calibration analysis where the calibrant ions are first calibrant ions having a first set of mass to charge ratios, and causing the TOF mass analyser to perform a second calibration analysis where the calibrant ions are second calibrant ions having a second set of mass to charge ratios different to the first set of mass to charge ratios of the first calibrant ions. As such, each of the first and second calibration analyses may cover a different mass to charge range of interest, wherein each of the first and second calibration analyses is performed with a different instrument parameter.

In some embodiments, the controller is configured to cause the TOF mass analyser to perform the plurality of calibration analyses comprising causing the TOF mass analyser to perform a first calibration analysis from which the controller determines a first refence calibration curve, the first reference calibration curve defined between a first mass to charge value and a second mass to charge value. The controller may also be configured to cause the TOF mass analyser to perform a second calibration analysis from which the controller determines a second reference calibration curve, the second reference calibration curve defined between a third mass to charge value and a fourth mass to charge value, wherein the fourth mass to charge value is outside the range defined by the first and second mass to charge values. As such, in some embodiments the mass to charge range defined by the third and fourth mass to charge values may partially overlap with the mass to charge range defined by the first and second mass to charge values. In some embodiments, the mass to charge range defined by the third and fourth mass to charge values may not overlap with the mass to charge range defined by the first and second mass to charge values. It will be appreciated that where a plurality of calibration analyses are provided, the mass to charge range of one or more of the calibration analyses may overlap with one or more of the other calibration analyses. Each of the calibration analyses may have a different instrument parameter setting. Accordingly, the plurality of reference calibration curves determined may provide information on the non-linearities associated with the instrument parameter for a range of different instrument parameter setting and for different mass to charge ranges.

In some embodiments, the controller is configured to determine a calibration curve based on the reference calibration curve of the plurality of reference calibration curves having an associated instrument parameter which is closest to the instrument parameter of the TOF mass analyser to be used in the TOF mass analysis.

In some embodiments, the controller is configured to determine a calibration curve by interpolating between two of the reference calibration curves having associated instrument parameters which bound the instrument parameter to be used in the TOF mass analysis. By using interpolation to determine a calibration curve, the method may take into account a plurality of reference calibration curves, which may improve the accuracy of the calibration.

According to a fourth aspect, a TOF mass analysis system configured to mass analyse a plurality of ions having a mass to charge ratio range of interest is provided. The TOF mass analysis system comprises a TOF mass analyser and a controller. The controller is configured to cause the TOF mass analyser to measure the flight times of a plurality of ions having a mass to charge ratio within the mass to charge range of interest, wherein the TOF mass analyser performs the measurement of the flight times with an associated instrument parameter of the TOF mass analysis system. The controller is also configured to determine a calibration curve for the TOF mass analyser. The controller determines the calibration curve based on a plurality of reference calibration curves, each reference calibration curve associated with a different value for the instrument parameter of the TOF mass analyser; and the instrument parameter of the TOF mass analysis system used to measure the flight times of the ions. The controller is also configured to apply the calibration curve to the measured flight times of the ions in order to determine mass to charge ratios for the ions.

As such, it will be appreciated that the TOF mass analysis system of the fourth aspect may be configured to perform the method of the second aspect of the disclosure. In some embodiments, the TOF mass analysis system of the fourth aspect may also be capable of performing the method of the first aspect.

In some embodiments, the TOF mass analysis system of the fourth aspect may comprise an ion preparation device, preferably an ion trap. In some embodiments, the ions to be measured are initially stored in the ion preparation device, which is connected to the TOF mass analyser, wherein for the measurement of the flight times of the ions the controller is configured to cause the ion preparation device to inject the ions from the ion trap into the TOF mass analyser. In some embodiments, the ion preparation device is configured to apply an RF trapping voltage in order to store the ions in the ion trap, wherein the instrument parameter associated with the measurement of the ions is an amplitude or frequency of the RF trapping voltage.

In some embodiments, the mass to charge range of interest and the instrument parameter are specified by a user.

In some embodiments, the mass to charge range of interest comprises a first subrange having an associated first instrument parameter and a second subrange having an associated second instrument parameter, the first and second instrument parameters being different. In some embodiments, the controller is configured to cause the TOF mass analyser to measure the flight times of the ions for each of the first and second subranges with the respective first and second instrument parameters. In some embodiments, the controller is configured to determine a first calibration curve for the first subrange, and to determine a second calibration curve for the second subrange, wherein the controller is configured to apply the first calibration curve to the measured flight times of the ions over the first subrange and to apply the second calibration curve to the measured flight times of the ions over the second subrange in order to determine mass to charge ratios for the ions.

According to a fifth aspect of the disclosure, a computer program comprising instructions to cause the TOF mass analysis system of the third or fourth aspects to execute the steps of the method according to the first and/or second aspects of the disclosure is provided.

According to a sixth aspect of the disclosure, a computer-readable medium having stored thereon the computer program of the fifth aspect is provided.

### BRIEF DESCRIPTION OF THE FIGURES

The disclosure will now be described with reference to the following non-limiting figures in which:

FIG. 1 is a schematic diagram of a TOF mass analysis system according to an embodiment of the disclosure;

FIG. 2 is a schematic diagram of a TOF mass analyser according to this disclosure;

FIG. 3 is a graph of a reference calibration curve;

FIG. 4 is a graph of the mass errors obtained from subsequent measurements of the same calibrant ions using a TOF mass analyser;

FIG. 5 is a graph showing the variation in m/z shift with RF trapping voltage;

FIG. 6 shows an oscilloscope trace of the signal applied to electrodes of an ion preparation device during a pulsed extraction process;

FIG. 7 is a block diagram of a method of calibrating a TOF mass analyser according to this disclosure;

FIG. 8 is a block diagram of a method of TOF mass spectrometry;

FIGS. 9A, 9B, and 9C show graphs of the measured m/z shift of sample ions of known m/z for TOF mass analyses under different instrument parameter settings;

FIG. 10 is a graph of a time of flight shift for RF trapping amplitude for calibrant ions of different m/z;

FIG. 11 is a graph of showing the variation in residual mass error across a range of m/z values and for different RF trapping voltages;

FIG. 12A shows a graph of a time of flight shift for RF trapping amplitude for calibrant ions of different m/z, and FIG. 12B shows a graph of residual mass errors (in ppm) for the same calibrant ions.

### DETAILED DESCRIPTION

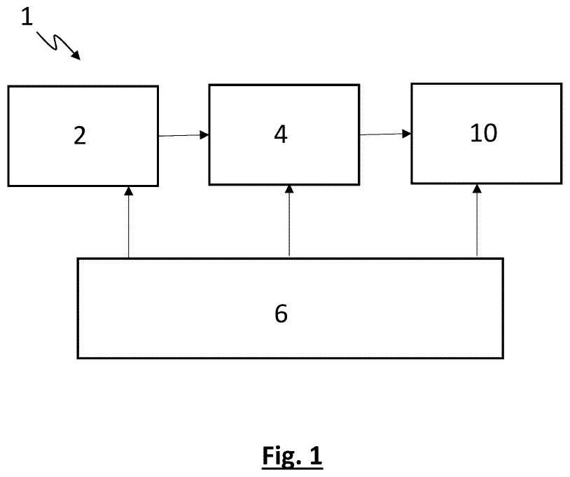

According to an embodiment of the disclosure, a TOF mass analysis system 1 is provided. A schematic diagram of the TOF mass analysis system is shown in FIG. 1. The TOF mass analysis system 1 comprises an ion source 2, an ion preparation device 4, a controller 6 and a TOF mass analyser 10.

The ion source 2 is configured to provide a source of ions for analysis by the TOF mass analyser 10. The ion source 2 may be configured to ionise sample molecules to produce sample ions which are to be analysed by the TOF mass analyser 10. In some embodiments, the ion source 2 may be an electrospray ionisation source. In some embodiments, the ion source 2 may be configured to ionise a stream of sample molecules provided from a chromatographic apparatus (not shown in FIG. 1).

The ion preparation device 4 is configured to receive ions from the ion source 2. Ions may be accumulated (stored) in the ion preparation device 4. The ion preparation device 4 may comprise a plurality of electrodes arranged to define an ion storage volume in which ions are stored. The ion preparation device 4 may be configured to apply one or more voltages to the electrodes in order to receive, trap, and eject ions from the ion storage volume. The ion preparation device 4 is configured to eject the stored ions from the ion preparation device (directly) into the TOF mass analyser 10. In some embodiments, the ion preparation device 4 may be an ion trap. For example, the ion trap may be a linear ion trap or a curved ion trap (C-trap).

The ion preparation device 4 may be configured to store ions received from the ion source 2 until a desired number of ions have been accumulated in the ion preparation device 4, or until a predetermined time period has elapsed, following which the ion preparation device 4 may eject the stored ions into the TOF mass analyser 10. The ion preparation device 4 may be configured to store ions by applying an RF trapping voltage to electrodes of the ion preparation device 4. The RF trapping voltage applied has an RF voltage amplitude and an RF voltage frequency. Trapped ions may be ejected from the ion preparation device 4 by application of an ejection voltage to the electrodes of the ion preparation device 4.

In some embodiments, other ion transport devices (not shown in FIG. 1) may be provided as part of the TOF mass analysis system 1. For example, the TOF mass analysis system may also comprise a fragmentation chamber configured to fragment (precursor) ions to generate product ions. The TOF mass analysis system may also comprise a mass selection device (e.g. a quadrupole mass selector) configured to select the mass to charge ratios of the ions provided to the ion preparation device 4. Fragmentation chambers and mass selection devices are well known to the skilled person and are not further described herein.

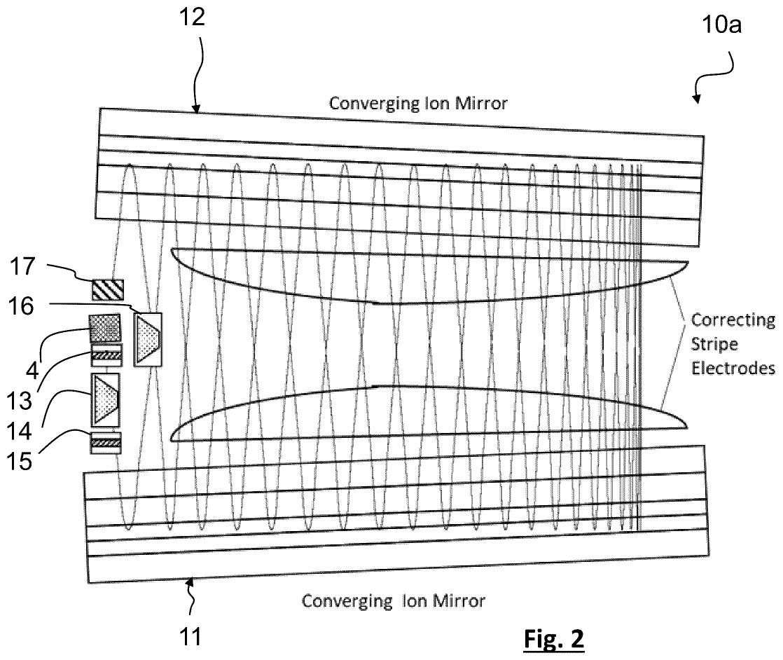

The TOF mass analyser 10 is configured to receive ions from the ion preparation device 4. In some embodiments, the TOF mass analyser 10 may be a multiple reflection TOF mass analyser (MR-TOF). A schematic diagram of an MR-TOF mass analyser 10a is shown in FIG. 2.

The MR-ToF 200 comprises a first converging ion mirror 11 and a second converging ion mirror 12. The first and second converging ion mirrors 11, 12 are arranged opposite each other in order to define an ion trajectory which involves multiple reflections between the first and second converging ion mirrors 11, 12. As further shown in FIG. 2, ions are input into the MR-ToF 10a from the ion preparation device 4. The ions travel from the ion preparation device 4 through a first out-of-plane lens 13, a first deflector 14, a second out-of-plane-lens 15, and a second deflector 16, before travelling between the converging ion mirrors 11, 12. Ions leaving the MR-ToF 10a are captured by an ion detector 17. Further details of the MR-TOF 10a may be found in at least U.S. Pat. No. 9,136,101.

While the following description of the calibration of a TOF mass analyser 10 will discuss the calibration of the MR-TOF 10a of FIG. 2, it will be appreciated that the method may also be applied to other TOF mass analysers 10. As such, the method of calibrating a TOF mass analyser 10 according to this disclosure may be applied to any TOF mass analyser 10.

TOF mass analysers 10 are generally capable of determining the m/z ratio of ions within an accuracy of about 5 ppm (parts per million), more preferably up to about 1 ppm.

In brief, the ion time-of-flight t may be expressed as a function of effective path length L, energy induced per charge by the acceleration voltage U in units of electron Volts, and mass/charge ratio of the ion m/z:

$$t = \frac{L}{\sqrt{2 U}} \sqrt{m / z}$$

Therefore, as m/z˜t², one method for calibrating a TOF mass analyser involves measuring the time-of-flight of a plurality of calibrant ions of known m/z. The calibrant ions may be provided a part of a calibration mixture (for example Pierce™ Flexmix™) which is ionised by the ion source 2. The measured flight times may then be used to fit parameters from a 2nd order polynomial calibration function.

$$m / z = {At}^{2} + Bt + C$$

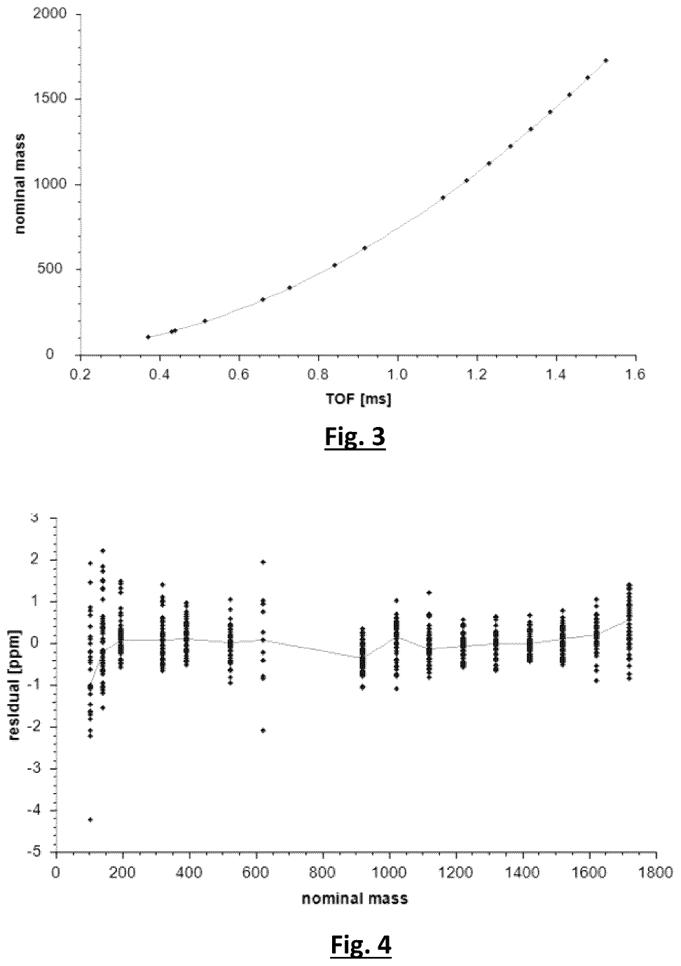

Polynomial-based calibration methods have been found to be suitable for TOF mass analysers, including MR-TOFs such as the MR-TOF of FIG. 2. For these instruments, the significance of measurement influences resulting from variations in the ion source (for example voltage variations during ion injection) are reduced due to the greater proportion of total flight time spent in the main analyser volume. FIG. 3 shows a calibration curve fitted to measured flight times of calibrant ions obtained from an MR-ToF analyser 10a of known m/z. FIG. 4 shows the m/z errors obtained from subsequent measurements of the same calibrant ions using the MR-TOF mass analyser 10a and the determined calibration curve. The solid line shows the average m/z error for the plurality of measurements of each calibrant ion of known m/z. As shown in FIG. 4, the m/z accuracy for most measurements is less than 1 ppm, although measurements occur where shot-to-shot jitter or ion statistical uncertainty adds some excess error.

While the calibration curve obtained in FIG. 3 can calibrate a TOF mass analyser 10 to have a mass accuracy of about 1 ppm, the calibration is most accurate where the TOF mass analyser 10 is operated under the same conditions as the calibration measurements. As such, variation of one or more instrument parameters of the TOF mass analysis system 1 can cause deviation from the simple calibration curve. This is because the calibration curve is effectively an approximation of often very complex ion flight paths, incorporating regions of acceleration/deceleration, focusing and considerable divergence in ion energies and trajectories. Some of these divergences are considerably m/z dependent. For example, the rise time of the pulsed extraction voltage induces an m/z dependency in ion energy as lighter ions move further across the acceleration field during its rise. Ripple on pulsed extraction induces similar issues. Another example is that RF trapping and space charge causes high m/z ions to disperse more widely in the ion source, and consequently have a greater energy spread after pulsed extraction. As such, while the following discussion of the calibration of a TOF mass analysis system 1 focuses on the effect of RF trapping voltages, it will be appreciated that the calibration techniques discussed herein may be applied to account for any non-linear effects associated with any instrument parameter of a TOF mass analysis system 1.

The present inventors have realised that for TOF mass analysis systems comprising an ion preparation device 4 that both RF traps ions and pulse extracts them into the TOF mass analyser 10, variation in instrument parameters associated with the ion preparation device may be highly m/z dependent. As such, the inventors have realised that variation of the trapping RF amplitude of the ion preparation device 4 produces very substantial shifts in measured m/z. Moreover, the variation in measured m/z with trapping RF amplitude is highly non-linear and m/z dependent, such that the variation is challenging to capture with a single calibration curve.

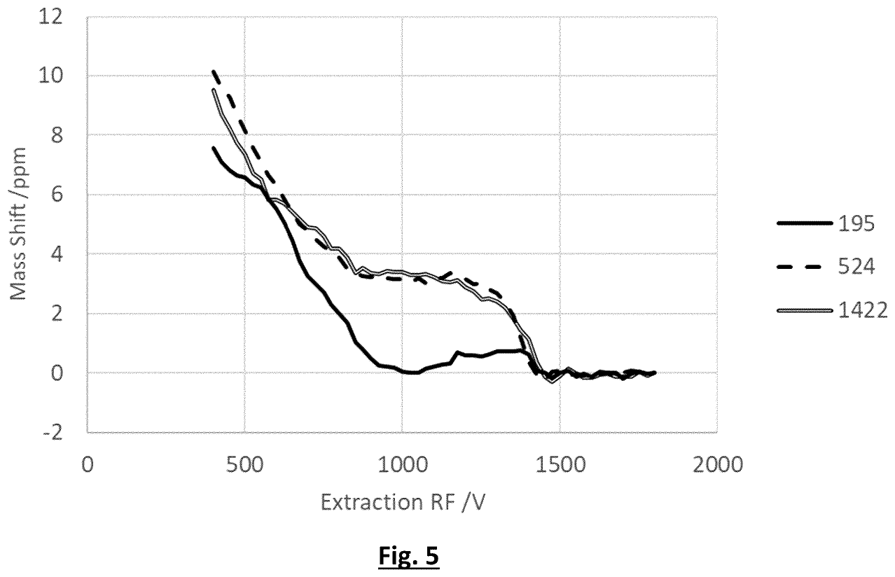

FIG. 5 is a graph of the variation in measured m/z for three different calibrant ions with RF trapping voltage amplitude varying from 400 V to 1800 V. Three calibrant ions having a known m/z of 195, 524, and 1422 respectively were mass analysed using the TOF mass analysis system 1, wherein different RF trapping voltage amplitudes were used. The measured m/z of each calibrant ion was compared to the known m/z in order to determine the mass shift (in ppm) for different RF trapping voltages. As shown in FIG. 5, the variation in instrument parameter causes a mass shift of about 10 ppm across the range of RF trapping voltages analysed, which is about an order of magnitude higher than the desired mass accuracy of 1 ppm. Furthermore, it will be appreciated that the nature of the mass shift is highly m/z dependent (e.g. around RF trapping voltages of about 1000 V) and highly non-linear. Instrument parameter dependent mass shifts of up to about 60 ppm have been observed on other TOF mass analysis systems. It will be appreciated that the multi-dimensional, non-linear relationship between these parameters means that calibrating a TOF mass analyser to account for these parameters using a single calibration measurement is challenging.

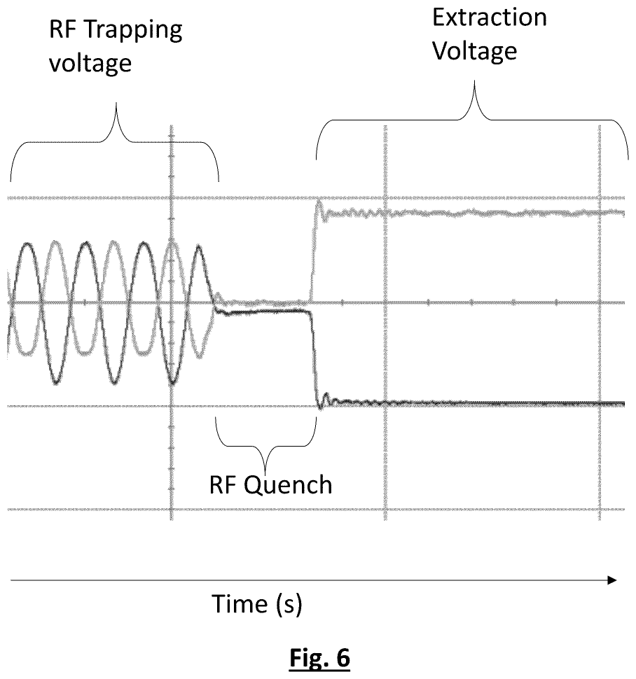

For the RF trapping voltage, the source of the mass shift is believed to result from interference from residual RF that interferes with the pulsed extraction process. FIG. 6 shows an oscilloscope trace of the signal applied to electrodes of the ion preparation device 4 during the pulsed extraction process, which acts in a manner described in detail by Hock in U.S. Pat. No. 9,548,195. RF is first quenched near the zero-crossing points (optionally at different points for different phases), there is an optional short delay and then a 900V pulsed extraction voltage is applied to the electrodes.

As shown in FIG. 6, opposing RF trapping voltages applied are applied to the electrodes of the ion preparation device 4 during a period of ion storage. During the ion ejection process, ions stored in the ion preparation device 4 are injected into the MR-TOF mass analyser 10a. It is believed that the overshoot and associated ringing introduces mass error which is m/z dependent. In particular, it is observed that the ringing on the extraction waveform, as well relatively small shifts in rise time and start point of the extraction waveform vary with the amplitude of the RF trapping voltage. In particular, these variations are observed in spite of the quenching of the RF trapping voltage. As such, even with advanced RF power supply design techniques to reduce RF overshoot and ringing (such as quenching), it is extremely challenging to entirely eliminate the relationship between RF trapping voltage and extraction voltages. As different RF trapping amplitudes are used by the ion preparation device to trap different m/z ranges of ions, it is not feasible to simply use a single value for the RF trapping voltage amplitude. For example, in the TOF mass analysis system 1 the RF trapping amplitude is normally adjusted scan-to-scan depending on the target m/z range of differing analytes. Thus, in order to improve m/z accuracy of the TOF mass analysis system 1, a method of calibrating the TOF mass analysis system 1 is desired which takes into account the instrument parameter(s) to be used in a specific TOF mass analysis scan.

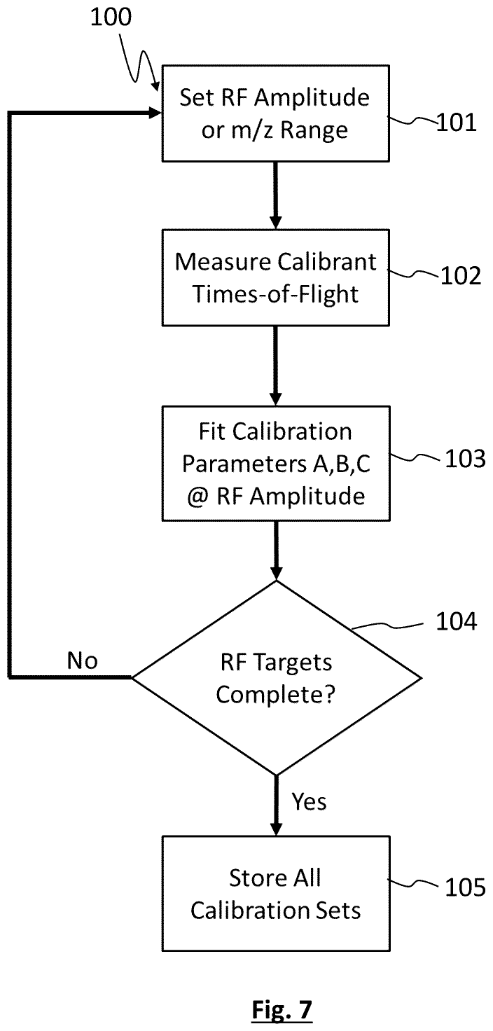

Thus, according to an embodiment of the disclosure a method 100 of calibrating the TOF mass analyser 10 of FIG. 1 is provided. FIG. 7 provides a block diagram of method 100 according to an embodiment of the disclosure.

According to the method 100, a plurality of calibration analyses of calibrant ions are performed using the TOF mass analyser 10. For each calibration analysis, the flight times of calibrant ions are measured using the TOF mass analyser 10, wherein the TOF mass analyser has an associated instrument parameter which has an effect on the flight times of the calibrant ions.

For example, in method 100, the instrument parameter is the RF trapping voltage amplitude of the ion preparation device 4. Thus, in steps 101, 102, 103, and 104 of method 100, a plurality of calibration analyses are performed using different RF trapping voltage amplitudes.

Thus, in step 101 the RF trapping voltage amplitude (instrument parameter) is selected from a list of RF trapping voltages to be measured. In general, the calibration should be performed over a range of instrument parameter values over which the TOF mass analysis system 1 is to be operated. For example, for the TOF mass analyser 10a, the calibration may be performed for RF trapping voltage amplitudes from about 400 V to about 1800 V at intervals of about 50 V for example. As such, at least 10, preferably at least 20 calibration analyses may be performed for the instrument parameter to be calibrated.

In step 102, the calibrant ions are analysed using the TOF mass analyser 10, wherein the selected instrument parameter is applied to the TOF mass analysis system 1.

In step 103, a reference calibration curve is determined for the TOF mass analyser 10 based on the known mass to charge ratios of the calibrant ions and the respective flight times. In some embodiments, the reference calibration curve determined may be a polynomial calibration curve. For example, the reference calibration curve may be of the form:

$$m / z = {At}^{2} + Bt + C$$

As such, in some embodiments, the reference calibration curve may be a polynomial of order at least: 2, 3 or 5. Determining a reference calibration curve may comprise fitting the parameters A, B, and C such that the measured m/z ratios of the calibrant ions are fitted to the known m/z ratios of the calibrant ions.

In step 104 of the method, the TOF mass analysis system 1 may assess whether reference calibration curves have been obtained for all instrument parameter settings of interest. As such, steps 101, 102 and 103 may be repeated at different instrument parameter settings in order to obtain the desired plurality of reference calibration curves.

In some embodiments, each calibration analysis may be performed using the same calibrant ions over the same m/z range.

In some embodiments, it may be desirable calibrate the TOF mass analysis system 1 over a relatively wide m/z range, such that different calibrant ions and/or different m/z ranges may be used for the calibration analyses.

For example, in some embodiments, one or more first calibration analyses may be performed where the calibrant ions are first calibrant ions having a first set of mass to charge ratios. In some embodiments, one or more second calibration analyses may also be performed where the calibrant ions are second calibrant ions having a second set of mass to charge ratios different to the first set of mass to charge ratios of the first calibrant ions. As such, the plurality of calibration analyses may use different calibrant ions (or different subsets of calibrant ions) in order to build up library of reference calibration curves over a relative broad m/z range with improved accuracy.

In some embodiments, the first calibration analyses may be performed over a first m/z range, and the second calibration analyses may be performed over a second m/z range. Accordingly, the first calibration analyses may be used to determined respective first reference calibration curves defined between a first mass to charge value and a second mass to charge value. The one or more second calibration analyses may be used to determine respective second reference calibration curves defined between a third mass to charge value and a fourth mass to charge value, wherein the fourth mass to charge value is outside the range defined by the first and second mass to charge values. As such, the first and second reference calibration curves may cover different m/z ranges. In some embodiments, the first and second reference calibration curves may overlap in m/z at least partially. As such, the plurality of calibration analyses may cover different m/z ranges in order to build up library of reference calibration curves over a relative broad m/z range with improved accuracy.

In step 105, the reference calibration curves may be stored by the TOF mass analysis system 1 for use at a later date. In some embodiments, as part of step 105 the TOF mass analysis system 1 may determine a calibration curve for use in a TOF mass analysis performed by the TOF mass analyser 10. The calibration curve may be determined based on the plurality of reference calibration curves and the instrument parameter of the TOF mass analyser to be used in the TOF mass analysis.

For example, in some embodiments a calibration curve is determined based on the reference calibration curve of the plurality of reference calibration curves having an associated instrument parameter which is closest to the instrument parameter of the TOF mass analyser to be used in the TOF mass analysis. As such, a reference calibration curve may be selected which was obtained under an instrument parameter setting which is most similar to the instrument parameter setting to be used in the TOF mass analysis.

In some embodiments, a calibration curve may be determined by interpolating between two of the reference calibration curves having associated instrument parameters which bound the instrument parameter of the ion trap to be used in the TOF mass analysis. For example, where the reference calibration curves are defined by a plurality of parameters (e.g. A, B, C, . . . etc.), a calibration curve may be determined by interpolation of each of the parameters between two sets of parameters (e.g. parameter A is obtained by interpolation between parameters A₁ and A₂ etc.).

While the above description describes a method for calibrating a TOF mass analyser for variations in RF trapping voltage, it will be appreciated that other instrument parameters may be calibrated using a similar methodology. For example, instrument parameters such as RF trapping voltage frequency, ion population per TOF mass analysis and the like may also be calibrated using similar techniques.

In some embodiments, a calibration curve may be determined which takes into account a variation in two (or more) instrument parameters. In such cases, the above described methods of determining a calibration curve may take into account a two-dimensional selection of reference calibration curves. For example, a reference calibration curve which is most similar to the combination of instrument parameters may be used to determine the calibration curve. In other embodiments, a two-dimensional interpolation of parameters A, B, C may be used to determine a calibration curve.

Thus, a calibration curve may be obtained which more accurately accounts for the effect of one or more instrument parameters on the calibration of the TOF mass analysis system 1.

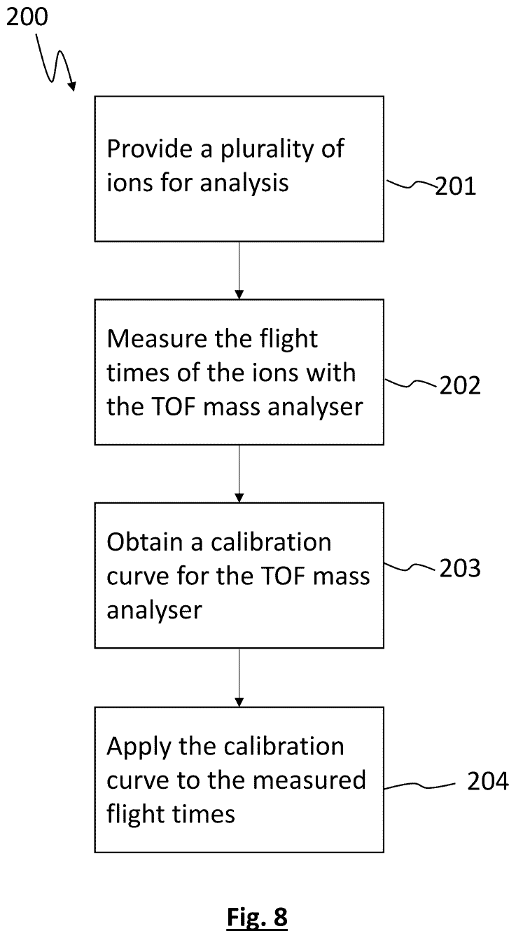

In addition to method 100 for calibrating the TOF mass analyser, according to a further embodiment of the disclosure a method 200 of TOF mass spectrometry for a mass to charge ratio range of interest is provided. FIG. 8 provides a block diagram of method 200. The method 200 will be discussed with reference to the TOF mass analysis system 1 discussed above.

In step 201, a plurality of ions having mass to charge ratios within the mass to charge ratio range of interest are provided. For example, the plurality of ions may be sample ions to be analysed. The sample ions may be provided by the chromatographic apparatus.

In step 202, the flight times of the ions may be measured using the TOF mass analyser 10, wherein the TOF mass analyser has an associated instrument parameter used to measure the flight times. For example, where the instrument parameter is RF trapping voltage, the RF trapping voltage may be selected based on the m/z range of the ions to be analysed. It will be appreciated that steps 201 and 202 of providing and mass analysing ions may be performed in a similar manner to the calibration analyses discussed above, and so these steps will not be discussed in further detail.

In step 203, a calibration curve for the TOF mass analyser is obtained. The calibration curve is obtained based on a plurality of reference calibration curves, each reference calibration curve associated with a different value for the instrument parameter of the TOF mass analyser; and the instrument parameter of the TOF mass analyser used to measure the flight times of the ions. It will be appreciated that the reference calibration curves may be obtained using the method of calibrating the TOF mass analysis system described above.

In step 204, the calibration curve is applied to the measured flight times of the ions in order to determine mass to charge ratios for the ions.

In some embodiments, the mass to charge range of interest comprises a first subrange having an associated first instrument parameter and a second subrange having an associated instrument parameter, the first and second instrument parameters being different. Thus, for TOF analyses where it is desirable to change instrument parameter settings for different m/z range, the method 200 may update the calibration curves used accordingly.

Thus in some embodiments of method 200, step 202 comprises measuring the flight times of the ions having a mass to charge ratio within the first subrange using the first instrument parameter; and measuring the flight times of the ions have a mass to charge ratio within the second subrange using the second instrument parameter. In such embodiments, in step 203 a first calibration curve is determined for the first subrange and a second calibration curve is determined for the second subrange. The associated calibration curves are then applied in step 204 in order to determine the m/z of the ions.

Thus, according to method 200, the calibration curve used for the TOF mass analysis system 1 may be determined on a per-measurement basis. As such, where a TOF mass analysis workflow is to be performed comprising a plurality of TOF measurements in which the instrument parameter is varied, the calibration of the TOF mass analyser may be adjusted to compensate for any mass shift associated with the variation in the instrument parameter.

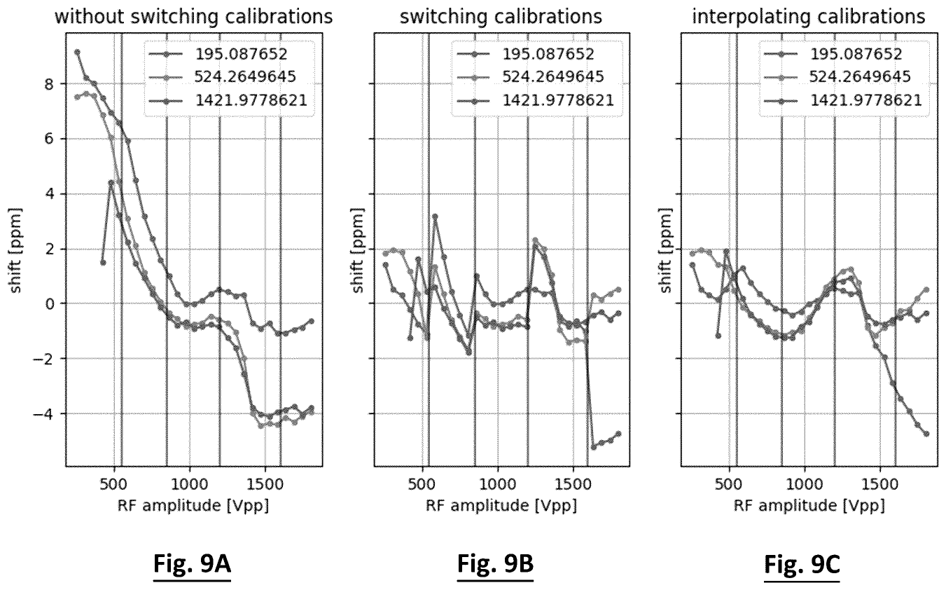

FIGS. 9A, 9B, and 9C show graphs of the measured m/z shift of sample ions of known m/z for TOF mass analyses under different instrument parameter settings. The measurements in FIGS. 9A, 9B, and 9C were obtained using a TOF mass analysis system 1 described above. In the examples of FIGS. 9A, 9B, and 9C, the instrument parameter varied is RF trapping voltage. For each data point, a time of flight was measured for the sample ions of interest under the specified RF trapping voltage. A calibration curve was then applied, and the determined m/z of the sample ion was compared to the known m/z of the sample ion in order to determine the mass shift (in ppm). In each of the graphs, sample ions of m/z 195.87652, 524.2649645, and 1421.9778621 corresponding to caffeine 915, MRFA 524 and Ultramark 1422 were analysed. The sample ions were measured over a range of RF trapping voltages from 400 V to 1800 V.

In the example of FIG. 9A, the same calibration curve was used for each measurement. The calibration curve used was obtained using an RF trapping voltage of about 800 V. It will be appreciated that using a single calibration curve for all measurements results in a mass shift ranging from about +9 ppm to −5 ppm (total range about 14 ppm) as the RF trapping voltage is varied. The average mass shift error was about 5 ppm. It will be appreciated that the variation in m/z shift with m/z is highly non-linear. The variation in m/z shift with RF trapping voltage is also highly non-linear. Thus, it will be appreciated that it is extremely difficult to provide a single calibration curve which accurately compensates for these effects.

Turning to FIG. 9B, a plurality of reference calibration curves were provided from which a calibration curve was determined for each TOF measurement. The plurality of calibration curves were obtained at RF trapping voltages of 600 V, 800 V, 1200 V and 1600V.

In FIG. 9B, each calibration curve was determined based on the reference calibration curve of the plurality of reference calibration curves having an associated instrument parameter which is closest to the instrument parameter of the TOF mass analyser to be used in the TOF mass analysis. It will be appreciated that for the method of FIG. 9B, the m/z shift ranged between about +2 ppm and −2 ppm for a substantial majority of the measurements. While a larger m/z shift was apparent for ions of m/z 195 at an RF trapping voltage of about 1400 V, this is a reflection that such large trapping voltages are not particularly suitable for accurate measurements of relatively low m/z ions.

In FIG. 9C, the plurality of reference calibration curves were provided from which a calibration curve was determined for each TOF measurement using interpolation. For these measurements, the average m/z shift was about 1 ppm, a further improvement on the method of FIG. 9B.

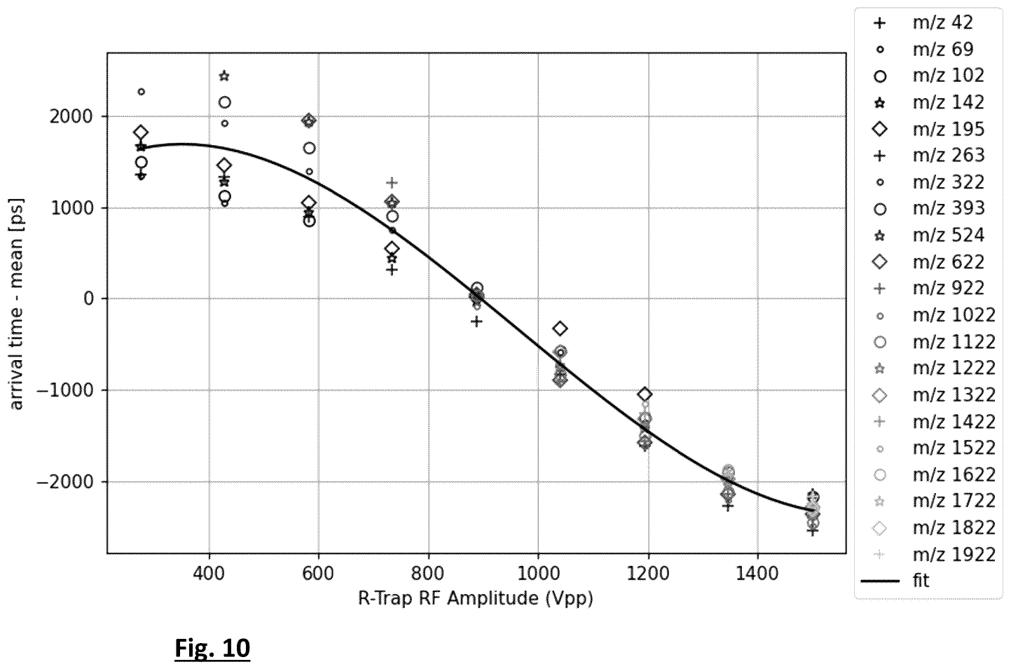

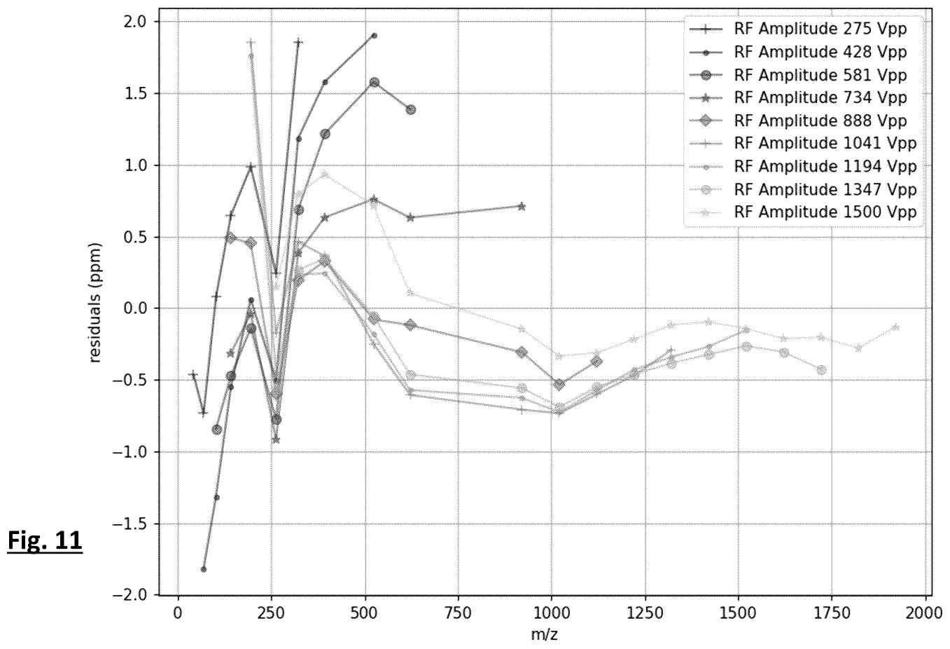

As discussed above, in some embodiments, the amplitude of the RF trapping voltage may, at least in part cause a shift in the determined m/z of an ion. This shift may be observed as a shift in the observed time of flight (flight time) for an ion of a known m/z. As such, in some embodiments the plurality of calibration analyses may be used to determine a time of flight shift for a given instrument parameter (RF trapping voltage). FIG. 10 shows a graph of a time of flight shift (i.e. the difference between the measured time of flight and the expected time of flight for an ion of known m/z) for different RF trapping voltages. FIG. 10 shows the time of flight shift with RF trapping voltages for ions of different known m/z.

As will be appreciated from FIG. 10, the time of flight shift behaviour can be characterised by a polynomial function. For example, in the embodiment of FIG. 10, the time of flight shift (tₛ) with RF trapping amplitude (A) can be found by fitting to the measured data a model of the form:

$${t}_{s} ( A ) = {c}_{0} + {c}_{1} A + {c}_{2} {A}^{2} + {c}_{3} {A}^{3}$$

where c₀, c₁, c₂, c₃ are parameters to be fitted to the determined time of flight shifts from the plurality of calibration analyses.

This RF trapping voltage dependent time of flight shift can be incorporated in the process of determining a plurality of reference calibration curves and/or the determining of a calibration curve for use in a TOF analysis.

For example, in some embodiments, reference calibration curves of the form m/z=At²+Bt+C may be determined based on a time of flight value t which is updated based on the time of flight shift. As such, prior to finding RF amplitude dependent model parameters, an RF amplitude dependent time of flight shift t (A) can be subtracted from the arrival time. This offset can be found by fitting a model of the form:

$$t ( m , A ) = {t}_{m} ( m ) + {t}_{s} ( A )$$

to calibration data that has been obtained using different (singly charged) calibrant ion species of known mass m and under known RF amplitudes A. Here, tₘ is an offset parameter for each known calibrant ion mass and the model t (A) for the RF amplitude dependent time of flight shift is mass independent. In FIG. 10, the model t (A) was chosen as a simple polynomial of order 3.

For example, in some embodiments, an initial estimate for the model may be based on a linear fit using the calibration data:

$$t ( m , A ) = {{a}_{0} ( t - t ( A ) )}^{2}$$

In such an embodiment, the parameters aₒ, c₀, c₁, c₂, c₃ may be estimated initially using a linear fit of the calibration data. In some embodiments, the model may be further refined using a curve fitting algorithm. For example, a Levenberg-Marquardt algorithm (damped least-squares) algorithm may be used to refine the estimated parameters in order to improve the model behavior.

In some embodiments, the updated time of flight value t (m, A) may then be used to determine an associated reference calibration curve of the form m/z=At²+Bt+C according to the methods as discussed above. As such, the reference calibration curve for each calibrant ion may be modelled as:

$$\frac{m}{z} = c ( A ) + b ( A ) ( t - t ( A ) ) + a ( A ) {( t - t ( A ) )}^{2}$$

where a (A), b (A), and c (A) are RF-dependent parameters to be fitted.

FIG. 11 shows a graph of the residual mass errors (in ppm) for ions of known mass to charge ratio which are analysed in accordance with one or more reference calibration curves having RF dependent parameters a (A), b (A), and c (A). It will be appreciated that the residual errors are no greater than ±2 ppm across a m/z range from 40 to 1900.

Alternatively, another possible model for each reference calibration curve to obtain the m/z from a given arrival time t and RF amplitude A could be of the form:

$$\frac{m}{z} = {a}_{0} ( A ) {( t - {t}_{0} - t ( A ) )}^{2}$$

where to is a time of flight/mass dependent parameter and a₀ is an RF-dependent parameter to be fitted.

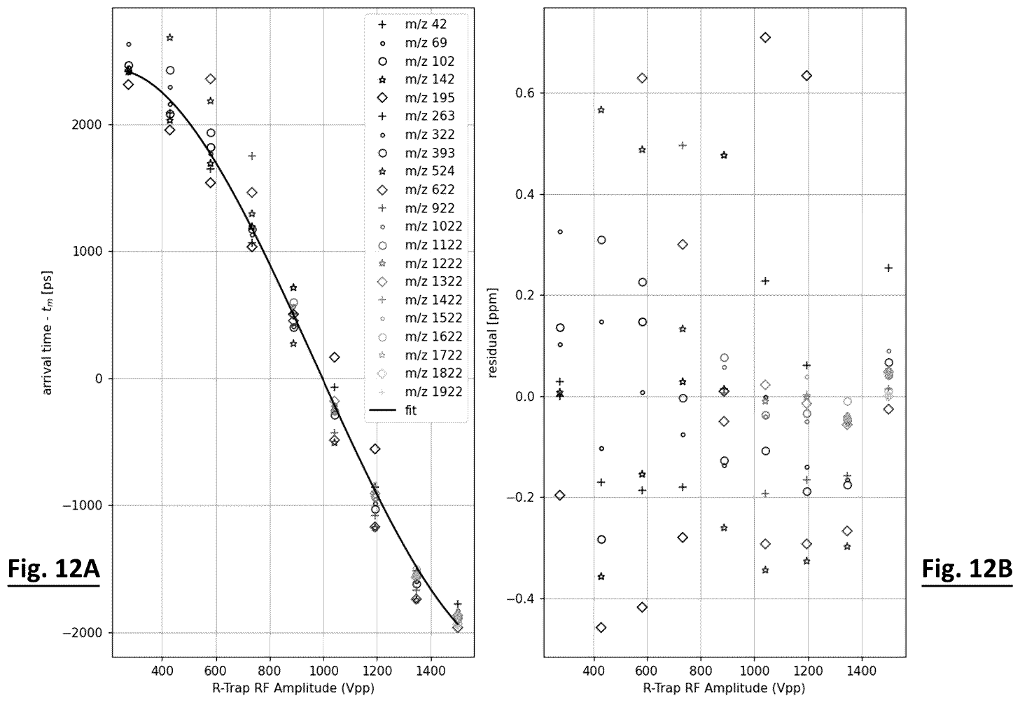

FIG. 12A shows a further graph of the variation in time of flight shift with RF trapping voltage amplitude. As will be appreciated from FIG. 12A, the time of flight shift is dependent on RF trapping voltage, but also has a (less significant) dependency on the m/z (i.e. the time of flight) of the calibrant ion. FIG. 12B shows the residual mass error (in ppm) for each data point of FIG. 12A.

So, in some embodiments, the determination of each reference calibration curve may be a multi-stage process in which the time of flight data is first shifted to account for the influence of the RF trapping voltage on time of flight, followed by determining a reference calibration curve which takes into account any m/z dependent behavior.

As such, in some embodiments, the multi-stage process for determining each reference calibration curve may take into account a plurality of instrument parameters. For example, in some embodiments the RF trapping voltage behavior may be accounted for in a step of calculating the time of flight shift. A reference calibration curve may then be determined based on a different instrument parameter (e.g. RF trapping voltage frequency, ion population per TOF mass analysis and the like) using the time-shifted time of flight measurements.

Thus, in accordance with embodiments of this disclosure methods of calibrating a TOF mass analyser and performing TOF mass analysis are provided.

1. A method of calibrating a Time of Flight (TOF) mass analyser comprising:
performing a plurality of calibration analyses of calibrant ions using the TOF mass analyser, each calibration analysis comprising:
measuring the flight times of the calibrant ions using the TOF mass analyser, wherein the TOF mass analyser has an associated instrument parameter which has an effect on the flight times of the calibrant ions; and
determining a reference calibration curve for the TOF mass analyser based on the known mass to charge ratios of the calibrant ions and the respective flight times, wherein the reference calibration curve is associated with the instrument parameter of the TOF mass analyser for the respective calibration analysis,
wherein for each of the plurality of calibration analyses, a value of the instrument parameter of the TOF mass analyser is different; and
determining a calibration curve for use in a TOF mass analysis performed by the TOF mass analyser, wherein the calibration curve is determined based on the plurality of reference calibration curves and the instrument parameter of the TOF mass analyser to be used in the TOF mass analysis.

2. A method according to claim 1, wherein
the calibrant ions are initially stored in an ion preparation device, preferably an ion trap, connected to the TOF mass analyser, wherein measuring the flight times of the calibrant ions comprises injecting the calibrant ions from the ion trap into the TOF mass analyser.

3. A method according to claim 2, wherein
the calibrant ions are initially stored in the ion trap by applying an RF trapping voltage

4. A method according to claim 3, wherein
the instrument parameter associated with each reference calibration curve is an amplitude or frequency of the RF trapping voltage.

5. A method according to claim 3 or claim 4, wherein
a time of flight shift model is determined based on the measured flight times of each of the plurality of calibration analyses, the known m/z of the calibrant ions for each of the plurality analyses, and an amplitude of the RF trapping voltage for each the plurality of calibration analyses,
wherein each reference calibration curve is determined based on the known mass to charge ratios of the calibrant ions, the time of flight shift model, and the respective flight times.

6. A method according to claim 5, wherein
the flight times used to determine each reference calibration curve are based on the time of flight shift model and the measured flight time.

7. A method according to any of claims 1 to 6, wherein
the plurality of calibration analyses comprise:
a first calibration analysis where the calibrant ions are first calibrant ions having a first set of mass to charge ratios; and
a second calibration analysis where the calibrant ions are second calibrant ions having a second set of mass to charge ratios different to the first set of mass to charge ratios of the first calibrant ions.

8. A method according to any of claims 1 to 7, wherein
the plurality of calibration analyses comprise:
a first calibration analysis from which a first refence calibration curve is determined, the first reference calibration curve defined between a first mass to charge value and a second mass to charge value; and
a second calibration analysis from which a second reference calibration curve is determined, the second reference calibration curve defined between a third mass to charge value and a fourth mass to charge value, wherein the fourth mass to charge value is outside the range defined by the first and second mass to charge values.

9. A method according to any of claims 1 to 8, wherein
a calibration curve is determined based on the reference calibration curve of the plurality of reference calibration curves having an associated instrument parameter which is closest to the instrument parameter of the TOF mass analyser to be used in the TOF mass analysis.

10. A method according to any of claims 1 to 9, wherein
a calibration curve is determined by interpolating between two of the reference calibration curves having associated instrument parameters which bound the instrument parameter to be used in the TOF mass analysis.

11. A method of Time of Flight mass spectrometry for a mass to charge ratio range of interest using a TOF mass analyser comprising:
providing a plurality of ions having mass to charge ratios within the mass to charge ratio range of interest;
measuring the flight times of the ions using the TOF mass analyser, wherein the TOF mass analyser has an associated instrument parameter used to measure the flight times;
obtaining a calibration curve for the TOF mass analyser wherein, the calibration curve is obtained based on:
a plurality of reference calibration curves, each reference calibration curve associated with a different value for the instrument parameter of the TOF mass analyser; and
the instrument parameter of the TOF mass analyser used to measure the flight times of the ions; and
applying the calibration curve to the measured flight times of the ions in order to determine mass to charge ratios for the ions.

12. A method according to claim 11, wherein
the ions are initially stored in an ion preparation device, preferably an ion trap, connected to the TOF mass analyser, wherein measuring the flight times of the ions comprises injecting the ions from the ion trap into the TOF mass analyser.

13. A method according to claim 12, wherein
the ions are initially stored in the ion trap by applying an RF trapping voltage, wherein the instrument parameter associated with each reference calibration curve is an amplitude or frequency of the RF trapping voltage.

14. A method according to any of claims 11 to 13, wherein
the mass to charge range of interest and the associated instrument parameter are specified by a user.

15. A method according to any of claims 11 to 13, wherein
the mass to charge range of interest comprises a first subrange having an associated first instrument parameter and a second subrange having an associated second instrument parameter, the first and second instrument parameters being different, and wherein the method of TOF mass spectrometry comprises:
measuring the flight times of the ions having a mass to charge ratio within the first subrange using the first instrument parameter; and
measuring the flight times of the ions have a mass to charge ratio within the second subrange using the second instrument parameter, wherein
a first calibration curve is determined for the first subrange; and
a second calibration curve is determined for the second subrange.

16. A Time of Flight (TOF) mass analysis system comprising:
a Time of Flight (TOF) mass analyser; and
a controller,
wherein the TOF mass analysis system has an instrument parameter which is controlled by the controller, wherein the instrument parameter has an effect on the flight time of a calibrant ion,
the controller configured to:
cause the TOF mass analyser to perform a plurality of calibration analyses of calibrant ions, each calibration analysis comprising:
measuring the flight times of the calibrant ions using the TOF mass analyser; and
determining a reference calibration curve for the TOF mass analyser based on known mass to charge ratios of the calibrant ions and the respective flight times, wherein the reference calibration curve is associated with the instrument parameter of the TOF mass analyser for the respective calibration analysis,
wherein for each of the plurality of calibration analyses, a value of the instrument parameter of the TOF mass analyser is different; and
determine a calibration curve for use in a TOF mass analysis performed by the TOF mass analyser, wherein the calibration curve is determined based on the plurality of reference calibration curves and the instrument parameter of the TOF mass analyser to be used in the TOF mass analysis.

17. A TOF mass analysis system according to claim 16, further comprising
an ion trap configured to store calibrant ions and to inject calibrant ions into the TOF mass analyser,
wherein for each calibration analysis, the controller is configured to cause the ion trap to inject the calibrant ions from the ion trap into the TOF mass analyser.

18. A TOF mass analysis system according to claim 17, wherein
the ion trap is configured to apply an RF trapping voltage to store the calibrant ions in the ion trap, and
the instrument parameter associated with each reference calibration curve is an amplitude or frequency of the RF trapping voltage.

19. A TOF mass analysis system according to any of claims 16 to 18, wherein
the controller is configured to cause the TOF mass analyser to perform plurality of calibration analyses comprising:
causing the TOF mass analyser to perform a first calibration analysis where the calibrant ions are first calibrant ions having a first set of mass to charge ratios; and
causing the TOF mass analyser to perform a second calibration analysis where the calibrant ions are second calibrant ions having a second set of mass to charge ratios different to the first set of mass to charge ratios of the first calibrant ions.

20. A TOF mass analysis system according to any of claims 16 to 19, wherein
the controller is configured to cause the TOF mass analyser to perform the plurality of calibration analyses comprising:
causing the TOF mass analyser to perform a first calibration analysis from which the controller determines a first refence calibration curve, the first reference calibration curve defined between a first mass to charge value and a second mass to charge value; and
causing the TOF mass analyser to perform a second calibration analysis from which the controller determines a second reference calibration curve, the second reference calibration curve defined between a third mass to charge value and a fourth mass to charge value, wherein the fourth mass to charge value is outside the range defined by the first and second mass to charge values.

21. A TOF mass analysis system according to any of claims 16 to 20, wherein
the controller is configured to determine a calibration curve based on the reference calibration curve of the plurality of reference calibration curves having an associated instrument parameter which is closest to the instrument parameter of the TOF mass analyser to be used in the TOF mass analysis.

22. A TOF mass analysis system according to any of claims 16 to 21, wherein
the controller is configured to determine a calibration curve by interpolating between two of the reference calibration curves having associated instrument parameters which bound the instrument parameter to be used in the TOF mass analysis.

23. A TOF mass analysis system configured to mass analyse a plurality of ions having a mass to charge ratio range of interest comprising:
a TOF mass analyser; and
a controller,
wherein the controller is configured to:
cause the TOF mass analyser to measure the flight times of a plurality of ions having a mass to charge ratio within the mass to charge range of interest, wherein the TOF mass analyser performs the measurement of the flight times with an associated instrument parameter of the TOF mass analysis system;
determine a calibration curve for the TOF mass analyser wherein, the calibration curve is determined based on:
a plurality of reference calibration curves, each reference calibration curve associated with a different value for the instrument parameter of the TOF mass analyser; and
the instrument parameter of the TOF mass analysis system used to measure the flight times of the ions; and
apply the calibration curve to the measured flight times of the ions in order to determine mass to charge ratios for the ions.

24. A TOF mass analysis system according to claim 23, further comprising
an ion trap;
the ions to be measured are initially stored in an ion trap connected to the TOF mass analyser, wherein for the measurement of the flight times of the ions the controller is configured to cause the ion trap to inject the ions from the ion trap into the TOF mass analyser.

25. A TOF mass analysis system according to claim 24, wherein
the ion trap is configured to apply an RF trapping voltage in order to store the ions in the ion trap, wherein the instrument parameter associated with the measurement of the ions is an amplitude or frequency of the RF trapping voltage.

26. A TOF mass analysis system according to any of claims 23 to 25, wherein
the mass to charge range of interest and the instrument parameter are specified by a user.

27. A TOF mass analysis system according to any of claims 23 to 26, wherein
the mass to charge range of interest comprises a first subrange having an associated first instrument parameter and a second subrange having an associated second instrument parameter, the first and second instrument parameters being different,
wherein the controller is configured to:
cause the TOF mass analyser to measure the flight times of the ions for each of the
first and second subranges with the respective first and second instrument parameters, and
to determine a first calibration curve for the first subrange; and
to determine a second calibration curve for the second subrange,
wherein the controller is configured to apply the first calibration curve to the measured flight times of the ions over the first subrange and to apply the second calibration curve to the measured flight times of the ions over the second subrange in order to determine mass to charge ratios for the ions.

28. A computer program comprising instructions to cause the TOF mass analysis system of any of claims 16 to 27 to execute the steps of the method according to any of claims 1 to 15.

29. A computer-readable medium having stored thereon the computer program claim 28.
